(19) United States
(12) Patent Application Publication
(10) Pub. No.: US 2004/0086153 A1
(43) Pub. Date: May 6, 2004

(54) Methods and systems for recognizing road signs in a digital image

(76) Inventors: Yichang Tsai, Smyrna, GA (US); Jianping Wu, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/696,977

(22) Filed: Oct. 30, 2003

Related U.S. Application Data
(60) Provisional application No. 60/422,460, filed on Oct. 30, 2002.

(51) Int. Cl. G06K 9/00; G06K 9/62

(52) U.S. Cl. 382/104; 382/209

(57) ABSTRACT

Methods for recognizing road signs in a digital image are provided. One such method comprises: capturing a digital color image; correlating at least one region of interest within the digital color image with a template matrix, where the template matrix is specific to a reference sign; and recognizing the image as containing the reference sign, responsive to the correlating step.

### CROSS-REFERENCE TO RELATED APPLICATIONS

This application which claims the benefit of U.S. Provisional No. 60/422,460, filed Oct. 30, 2002.

### FIELD OF THE INVENTION

The present invention relates generally to image processing, and more particularly, to systems and methods for recognizing road signs in a digital image.

### BACKGROUND

Accurate and timely road inventory data can be used to support planning, design, construction and maintenance of a variety of highway transportation facilities. Features collected in a road inventory data collection system include a variety of traffic signs, pavement widths, lane numbers, and other characteristics of roads. Automating a road inventory data collection system using computers can result in a system that is more accurate, efficient, and safe than systems that rely on human input. However, in general, current systems are limited because they cannot process the road inventory data in real-time.

Detecting traffic signs in real-time is a particularly difficult problem. The outdoor environment is constantly changing, and factors such as variations in lighting, the presence of shadows, and weather conditions, all affect the data collection. Also, the signs may be tilted in different directions, or may be partially blocked by obstructions such as tree branches or posts. Thus, a heretofore unaddressed need exists in the industry for a solution to address the aforementioned deficiencies and inadequacies.

### SUMMARY

The present invention is directed to unique methods and apparatus for recognizing road signs in a digital image. A representative method, among others, comprises the steps of: capturing a digital color image; correlating at least one region of interest within the digital color image with a template matrix, where the template matrix is specific to a reference sign; and recognizing the image as containing the reference sign, responsive to the correlating step. A representative system, among others, comprises a computer system that is programmed to perform the above steps.

### DESCRIPTION OF THE DRAWINGS

The accompanying drawings illustrate several aspects of the present invention, and together with the description serve to explain the principles of the invention.

FIG. 1 illustrates an example of a general-purpose computer that can be used to implement an embodiment of a method for recognizing road signs in a digital image.

FIG. 2 is a flow chart of an example embodiment of the method for recognizing road signs in a digital image that is executed in the computer of FIG. 1.

FIG. 3 is a flow chart of the color segmentation step from FIG. 2 performed by an example embodiment that recognizes stop signs.

FIG. 4 is a flow chart of the ROI extraction step from FIG. 2 performed by one example embodiment that recognizes stop signs.

FIGS. 5A-C are a sequence of diagrams showing the ROI process of FIG. 4 as applied to an example matrix E.

FIG. 6 is a flow chart of the sign detection steps from FIG. 2 performed by an example embodiment that recognizes stop signs.

FIG. 7 is a flow chart of the sign detection steps from FIG. 2 performed by another example embodiment that recognizes stop signs.

FIG. 8 is a flow chart of the color segmentation step from FIG. 2 performed by yet another example embodiment that recognizes speed limit signs.

FIG. 9 is a flow chart of the ROI extraction step from FIG. 2 performed by an example embodiment that recognizes speed limit signs.

FIGS. 10A-C are a sequence of diagrams showing the ROI process of FIG. 9 as applied to an example matrix E.

FIG. 11 is a flow chart of the sign detection steps from FIG. 2 performed by an example embodiment that recognizes speed limit signs.

### DETAILED DESCRIPTION

Having summarized the inventive concepts of the present invention, reference is now made to the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

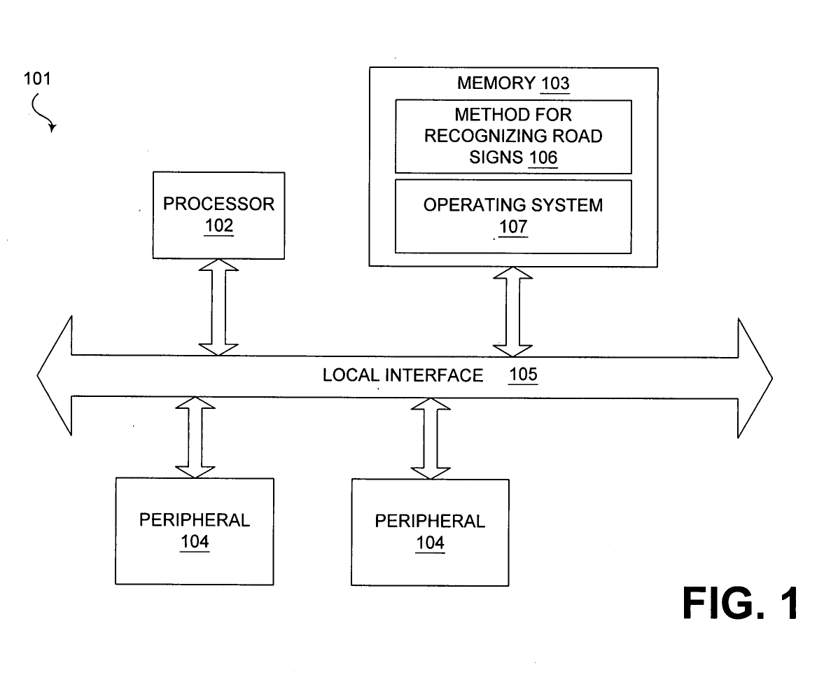

FIG. 1 illustrates an example of a general-purpose computer that can be used to implement an embodiment of a method for recognizing road signs in a digital image. Generally, in terms of hardware architecture, the computer 101 includes a processor 102, memory 103, and one or more input and/or output (I/O) devices or peripherals 104 that are communicatively coupled via a local interface 105. The local interface 105 can be, for example but not limited to, one or more buses or other wired or wireless connections, as is known in the art. The local interface 105 may have additional elements (omitted for simplicity), such as controllers, buffers, drivers, repeaters, and receivers, to enable communications. Further, the local interface 105 may include address, control, and/or data connections to enable appropriate communications among the aforementioned components.

The processor 102 is a hardware device for executing software, particularly that stored in memory 103. The processor 102 can be any custom made or commercially available processor, a central processing unit (CPU), an auxiliary processor among several processors associated with the computer 101, a semiconductor based microprocessor (in the form of a microchip or chip set), a microprocessor, or generally any device for executing software instructions.

The memory 103 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 103 may incorporate electronic, magnetic, optical, and/or other types of storage media. Note that the memory 103 can have a distributed architecture, where various components are situated remote from one another, but can be accessed by the processor 102.

The software in memory 103 may include one or more separate programs, each of which comprises an ordered listing of executable instructions for implementing logical functions. In the example of FIG. 1, the software in the memory 103 includes one or more components of the method for recognizing road signs in a digital image 106, and a suitable operating system 107. The operating system 107 essentially controls the execution of other computer programs, such as the method for recognizing road signs in a digital image 108, and provides scheduling, input-output control, file and data management, memory management, and communication control and related services.

The method for recognizing road signs in a digital image 109 is a source program, executable program (object code), script, or any other entity comprising a set of instructions to be performed. When a source program, then the program needs to be translated via a compiler, assembler, interpreter, or the like, which may or may not be included within memory 103, so as to operate properly in connection with the operating system 107.

The peripherals 104 may include input devices, for example but not limited to, a keyboard, mouse, scanner, microphone, etc. Furthermore, the peripherals 104 may also include output devices, for example but not limited to, a printer, display, etc. Finally, the peripherals 104 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 101 is a PC, workstation, or the like, then the software in the memory 103 may further include a basic input output system (BIOS) (omitted for simplicity). The BIOS is a set of essential software routines that initialize and test hardware at startup, start the operating system 107, and support the transfer of data among the hardware devices. The BIOS is stored in ROM so that the BIOS can be executed when the computer 101 is activated.

When the computer 101 is in operation, the processor 102 is configured to execute software stored within the memory 103, to communicate data to and from the memory 103, and to generally control operations of the computer 101 pursuant to the software. The method for recognizing road signs in a digital image 110 and the operating system 107, in whole or in part, but typically the latter, are read by the processor 102, perhaps buffered within the processor 102, and then executed.

When the method for recognizing road signs in a digital image 111 is implemented in software, as is shown in FIG. 1, it should be noted that the method for recognizing road signs in a digital image 112 can be stored on any computer readable medium for use by or in connection with any computer related system or method. In the context of this document, a “computer-readable medium” can be any means that can store, communicate, propagate, or transport the program for use by or in connection with the instruction execution system, system, or device. The computer-readable medium can be, for example but not limited to, an electronic, magnetic, optical, electromagnetic, infrared, or semiconductor system, system, device, or propagation medium. A nonexhaustive example set of the computer-readable medium would include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the method for recognizing road signs in a digital image 113 is implemented in hardware, the method for recognizing road signs in a digital image 114 can be implemented with any or a combination of the following technologies, which are each well known in the art: a discrete logic circuit(s) having logic gates for implementing logic functions upon data signals, an application specific integrated circuit(s) (ASIC) having appropriate combinatorial logic gates, a programmable gate array(s) (PGA), a field programmable gate array(s) (FPGA), etc.

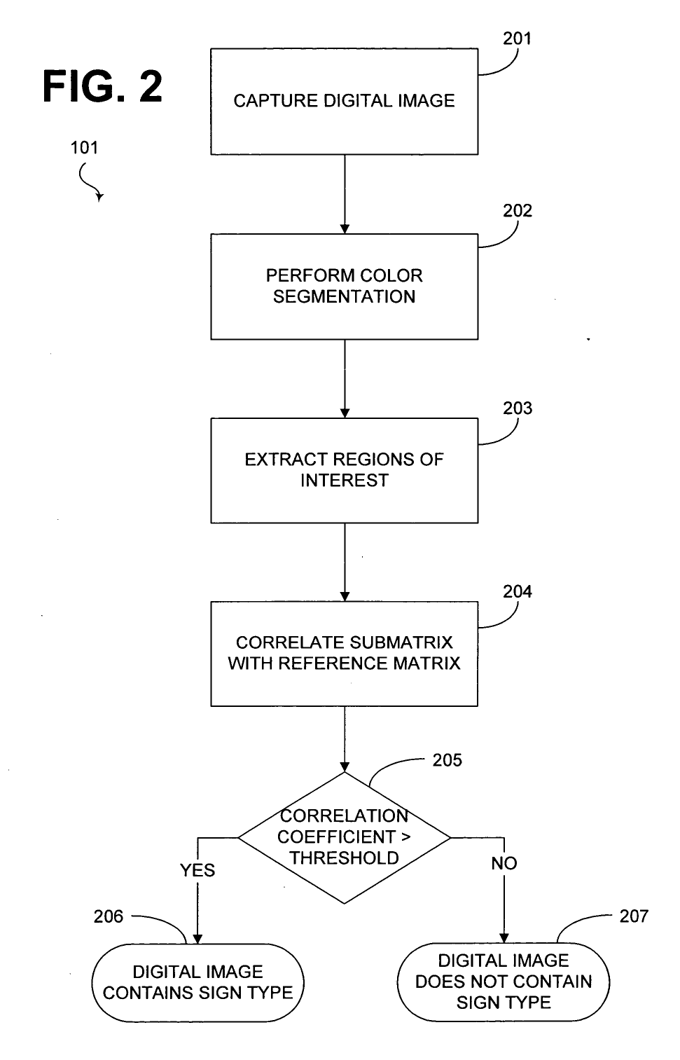

FIG. 2 is a flow chart of an example embodiment of the method for recognizing road signs in a digital image that is executed in the computer of FIG. 1. Processing begins at step 201, where a digital image is captured. Many techniques for digital image capture are known in the art, for example, using a digital still camera or a digital video camera, using an analog camera and converting the image to digital, etc. At the next step, step 202, color segmentation is performed on the captured digital image. In this manner, the digital image is segmented into multiple regions according to color. The next step is step 203. In step 203, regions of interest are extracted from the segmented image. A region of interest (ROI) is the smallest rectangular matrix that a road sign can reside in. Processing continues at step 204, where a correlation coefficient is computed for each ROI relative to a reference matrix. The reference matrix acts as a shape template for a particular road sign. At the next step, step 205, the correlation coefficient is compared to a threshold value. If the coefficient is above the threshold, the digital image does contain a road sign, of the type described by the reference matrix, and processing stops at step 206. Otherwise, the digital image does not contain a road sign, and processing stops at step 207.

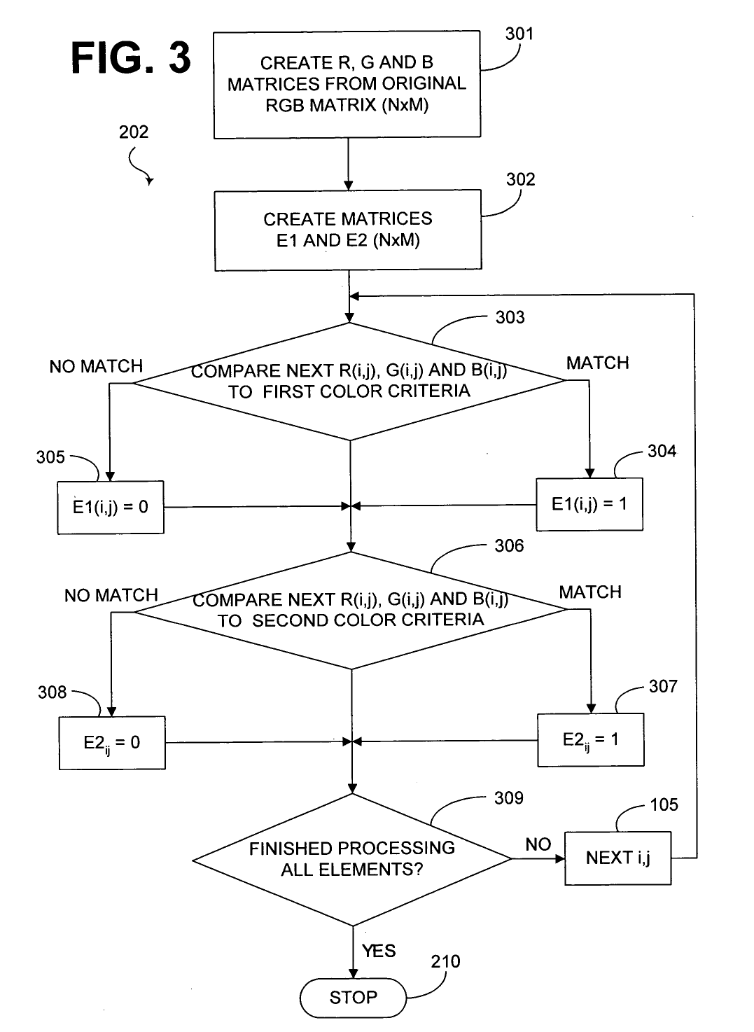

Several example embodiments will be described below. FIG. 3 is a flow chart of the color segmentation step (step 202 from FIG. 2) performed by an example embodiment that recognizes stop signs. In this example embodiment, the color segmentation process segments an image based on color characteristics of a stop sign, which is mostly red. Segmentation is performed by comparing the color components at each pixel location with color criterion.

In the RGB color model, the color “red” depends not only on the value of R, but also on the values of G and B. For example, a pixel with a relatively high R value is not “red” if its G and B values are higher than the R value. Thus, the color “red” is defined by some threshold R value in combination with equations relating R, G, and B values. Similarly, “green” is defined by a threshold G value in combination with equations relating R, G, and B, and “blue” is defined by a threshold B value in combination equations relating R, G, and B. For example, a color criterion for “red” could be defined as:

R>25 and R>1.25G and B−G>0.8(R−G)

Using a threshold value avoids false recognition of pixels below a background noise level. The equations relating all three colors in terms of each other specify a low bound of the saturation S in hue, saturation and intensity (HSI) model. For example, in the color criterion for “red” defined above, the low bound of the saturation S for the R component is:

$$S = \frac{( max ( R , G , B ) - min ( R , G , B ) )}{max ( R , G , B )} \geq \frac{R - G}{R} > \frac{1.25 G - G}{1.25 G} = 0.2$$

In this embodiment, multiple color criteria are used for the same color, and pixels that meet any of the criteria are considered a color match. Multiple color criteria are useful for different light conditions. For example, in bright light, a “red” pixel will have a higher saturation S than a “red” pixel in dim light. In this embodiment, which recognizes stop signs, the two color criteria used in the color segmentation process of FIG. 2 are “red,” defined as:

R>25 and R>1.25G and B−G>0.8(R−G)

R>25 and R>1.4G and B−G>0.4(R−G)

where the first criterion defines “red” (S=0.2) in dim light and the second criterion defines “red” (S=0.3) in bright light.

Returning now to the flow chart of FIG. 3, the captured digital image is represented by a Red/Green/Blue (RGB) matrix of size N×M. Each pixel location in the RGB matrix has a separate Red value, Green value, and Blue value. The color segmentation process begins with step 301, which separates the RGB matrix into an R matrix, a B matrix, and a G matrix, each having the same dimensions as the RGB matrix. The R matrix contains only the Red values from the corresponding pixel locations in the RGB matrix. Likewise, the B matrix contains only Blue values and the G matrix contains only Green values.

Processing continues at step 302, where two new matrices, named E1 and E2, are created. E1 and E2 have the same dimensions as the R, G, and B matrices. E1 and E2 are binary matrices, such that each element is limited to one of two values, for example, 0 or 1, True or False. At the end of the color segmentation process, E1 will contain 1/True values at those pixel locations where the corresponding locations in the R, G and B matrices meet a first color criterion. In other words, if the first color criterion describes “red,” then E1 will have 1/True values wherever pixels in R, G, and B are “red” according to that criterion. Similarly, E2 will contain 1/True values at pixel locations where the corresponding locations in the R, G and B matrices meet a second color criterion. In this embodiment, both color criterion describe the same basic color (e.g., “red”).

Returning to FIG. 2, after matrices E1 and E2 are created in step 302, processing continues at step 303. In step 303, the next elements in the R, G and B matrices are compared to the first color criterion. The next element is determined by the i,j indices. The comparison involves multiple matrices because, as described above, the color criterion uses R, G, and B values.

If the comparison is a match, then processing continues at step 304, where the corresponding element in E1 is set to True/1, signifying that this location in E matches the first color criterion. If the comparison is not a match, then processing continues at step 305, where the corresponding element in E1 is set to False/0, signifying that this location in E does not match the first color criterion. In either case, the next step executed is step 306.

In one embodiment which uses binary matrices for E1 and E2, the color criterion comparison is accomplished using a comparison matrix Z in which the matrix element equals 1 when the corresponding element of X is greater than that of Y, and 0 otherwise, as follows:

$$Z = X > Y = ( \begin{matrix}X ( 1 ) > Y ( 1 , 1 ) & X ( 1 , 2 ) > Y ( 1 , 2 ) & … & X ( 1 , n ) > Y ( 1 , n ) \\ X ( 2 , 1 ) > Y ( 2 , 1 ) & X ( 2 , 2 ) > Y ( 2 , 2 ) & … & X ( 2 , n ) > Y ( 2 , n ) \\ … & … & … & … \\ X ( m , 1 ) > Y ( m , 1 ) & X ( m , 2 ) > Y ( m , 2 ) & … & X ( m , n ) > Y ( m , n )\end{matrix} )$$

A binary matrix multiplication Z(m,n)=U×V is defined by:

$$Z = U \times V = ( \begin{matrix}U ( 1 , 1 ) \times V ( 1 , 1 ) & U ( 1 , 2 ) \times V ( 1 , 2 ) & … & U ( 1 , n ) \times V ( 1 , n ) \\ U ( 2 , 1 ) \times Y ( 2 , 1 ) & U ( 2 , 2 ) \times V ( 2 , 2 ) & … & U ( 2 , n ) \times V ( 2 , n ) \\ … & … & … & … \\ U ( m , 1 ) \times Y ( m , 1 ) & U ( m , 2 ) \times V ( m , 2 ) & … & U ( m , n ) \times V ( m , n )\end{matrix} )$$

Thus, every element in the product matrix Z(m,n) is the product of the corresponding elements in matrices U(m,n) and V(m,n), and the element Z(m,n) is equal to 1 if both the U(m,n) and V(m,n) elements are 1's; otherwise, it is 0.

The two example color criterion for “red” introduced above can thus be expressed using matrix multiplication, as:

E1=(R>25)×(R>1.25G)×(0.8(R−G)>(B−G))

E2=(R>25)×(R>1.4G)×(0.4(R−G)>(B−G))

where E1 is the binary matrix for dim lighting, E2 is the binary matrix for bright lighting, and R, G and B are the matrices for red, green and blue components.

Returning to FIG. 2, step 306 is similar to step 303, but uses the second color criterion for comparison instead of the first. If the comparison with the second color criterion is a match, then processing continues at step 307, where the corresponding element in E2 is set to True/1. If the comparison is not a match, then processing continues at step 308, where the corresponding element in E2 is set to False/0. In either case, the next step executed is step 309.

In step 309, a determination is made whether all elements in R, G, and B have been processed. If No, then processing continues at step 310, where the indices i,j are incremented to advance to the next element in R, G and B. Processing then continues for this next element at step 303. If Yes, then processing stops at step 309. At this point, binary segmentation matrices E1 and E2 contain 1's at locations that match the color criterion, and 0's at locations that do not match. These segmentation matrices are used as input to the ROI extraction process (step 203 from FIG. 2).

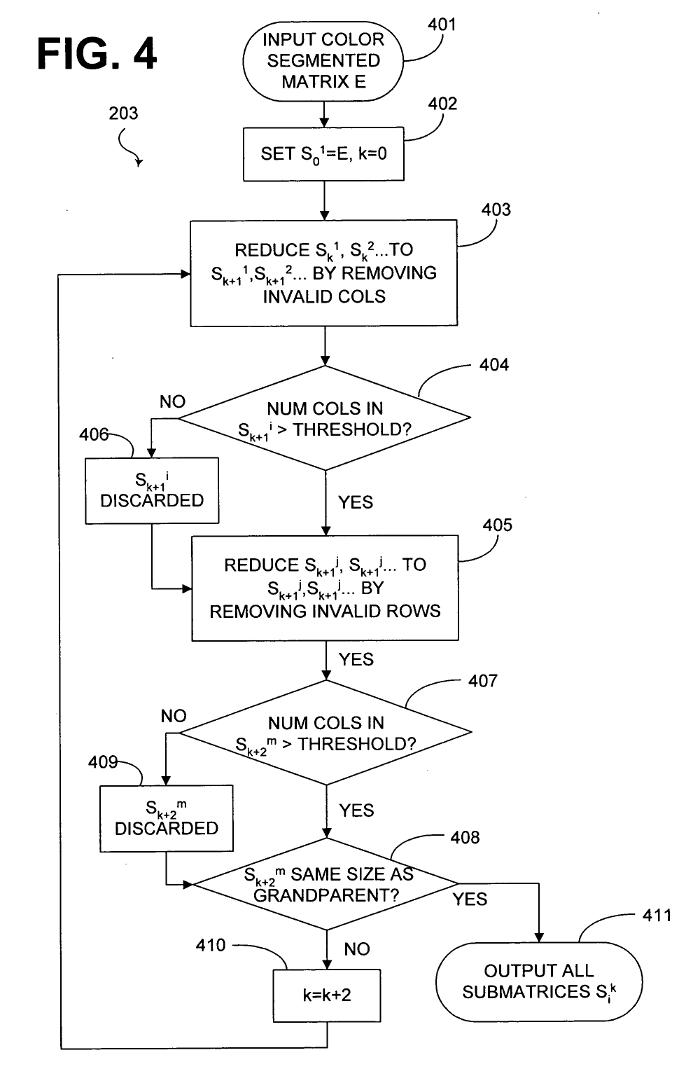

FIG. 4 is a flow chart of the ROI extraction step (step 203 from FIG. 2) performed by one example embodiment that recognizes stop signs. This process is performed independently on each of the binary E matrices (E1 and E2) which were produced by the color segmentation process of FIG. 2. The ROI extraction process finds submatrices Sₖⁱ within E, each of which potentially contains a stop sign. The determination is made based on distributions of color within E, where each row and each column in an ROI Sₖⁱ contains a sufficient number of 1's (indicating color). The ROI extraction process is performed recursively, starting with E as input, and then operating on any submatrices Sₖⁱ produced in the preceding iteration. Submatrix Sₖⁱ(x1:x2; y1:y2) covers columns from x1 to x2 and rows from y1 to y2. The notation Sₖⁱ indicates the i-th submatrix extracted by the k-th iteration of the process.

ROI extraction processing begins at step 401, where a binary matrix E is provided as input. The next step, step 402, initializes the first submatrix S₀¹ to E, and counter k to zero. At the next step, step 403, all remaining submatrices Sₖ¹, Sₖ² . . . are reduced matrix to submatrices Sₖ₊₁¹, Sₖ₊₁² . . . by removing invalid columns. An invalid column is a column that does not contain enough 1's, which means it is not a color match. One way to determine whether or not a column is invalid is to sum all elements in each column and compare the sum with a color threshold, which may be color-specific.

Processing continues at step 404, where the number of columns remaining in Sₖ₊₁ⁱ is compared to a size threshold. If the number of columns is more than the size threshold, processing continues at step 405. If the number of columns is less than the size threshold, the submatrix Sₖ₊₁¹ is discarded in step 406, then processing continues at step 405. By using a threshold to eliminate small regions, the number of regions processed by the compute-intensive detection stage (step 204 of FIG. 2) is reduced, thus improving computation time. In addition, small regions may not be consistently detected by the detection stage due to loss of detail.

Processing continues at step 405 after the threshold test. In step 405, all remaining submatrices Sₖ₊₁¹, Sₖ₊₁² . . . are reduced matrix to submatrices Sₖ₊₂¹, Sₖ₊₂² . . . by removing invalid rows. An invalid row is a row that does not contain enough 1's, which means it is not a color match. One way to determine whether or not a row is invalid is to sum all elements in each row, and compare the sum with a color threshold, which may be color-specific.

Processing continues at step 407, where the number of rows remaining in Sₖ₊₂^{m} is compared to a size threshold. If the number of rows is more than the size threshold, processing continues at step 408. If the number of rows is less, then the submatrix Sₖ₊₂^{m} is discarded in step 409, then processing continues at step 408. Step 408 determines if the submatrix Sₖ₊₂^{m} can be further reduced, by comparing its size to the size of its grandparent from two iterations ago, Sₖ₊₀^{m}.

If Sₖ₊₂^{m} can be further reduced, then the counter k is incremented by 2 in step 410. Then the process then repeats again starting with step 403, using submatrices Sₖ₊₂¹, Sₖ₊₂² . . . as input. In this way, the ROI extraction step proceeds in a recursive fashion until no submatrix Sₖⁱ can be further reduced. If Sₖ₊₂^{m} cannot be further reduced, then step 411 outputs all remaining submatrices Sₖⁱ as ROIs for use in a later stage of processing.

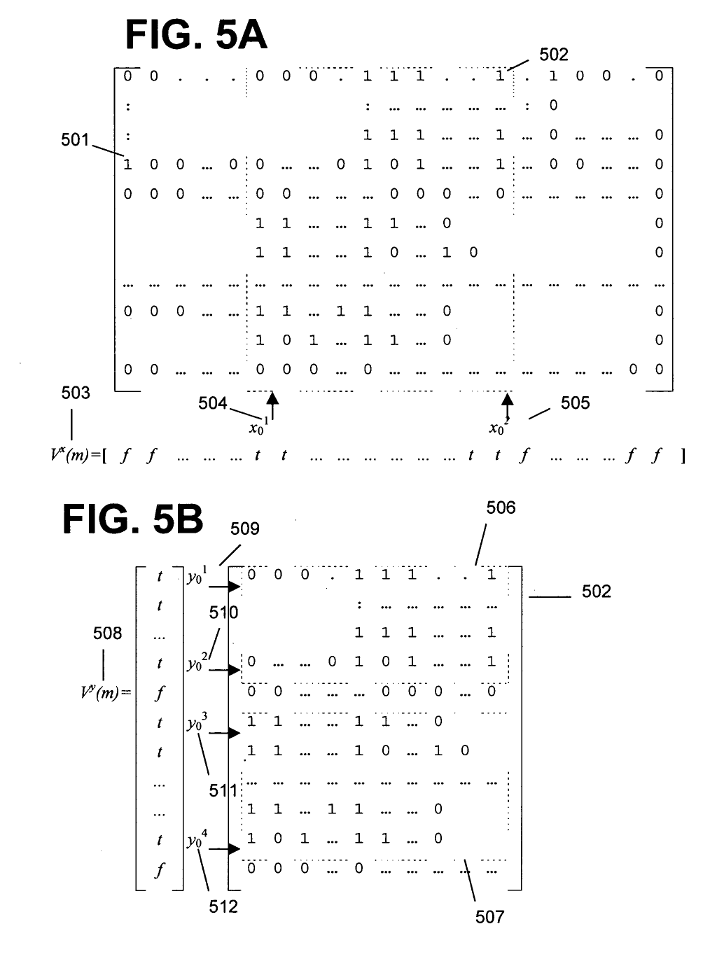

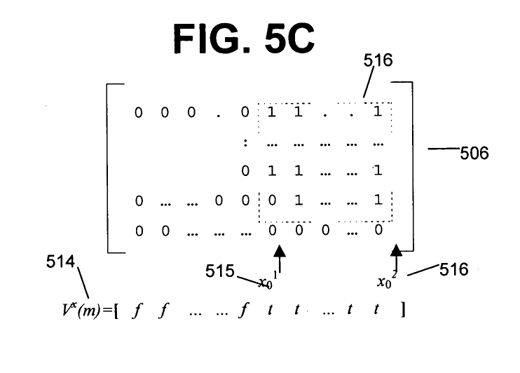

FIGS. 5A-C are a sequence of diagrams showing the ROI process of FIG. 4 as applied to an example matrix E (501). In the first iteration, shown in FIG. 5A, example matrix E (501) is reduced to submatrix S₁ (502) by removing invalid columns. Invalid columns are computed using vector V^{x}, as follows:

$${V}^{x} = \\ ( {\sum }_{i = 1}^{i = m} E ( i , 1 ) \geq threshold , {\sum }_{i = 1}^{i = m} E ( i , 2 ) \geq threshold , … {\sum }_{i = 1}^{i = m} E ( i , n ) \geq threshold )$$

V^{x} (503) then contains one element for each column, with each element having only one of two values: t if the column is valid; or f if the column is invalid. From V^{x}, the left boundary x₀¹ (504) and right boundary x₀² (505) of submatrix S₁ are extracted, so that S₁=E(x₀¹, x₀¹; 1, n).

FIG. 5B shows the second iteration, where submatrix S₁ (502) is reduced to submatrices S₂¹ (506) and S₂² (507) by removing invalid rows. Invalid rows are computed using vector V^{y}, as follows:

$${V}^{y} = \\ ( {\sum }_{i = 1}^{i = n} E ( 1 , i ) \geq threshold , {\sum }_{i = 1}^{i = n} E ( 2 , i ) \geq threshold , … {\sum }_{i = 1}^{i = n} E ( m , i ) \geq threshold )$$

V^{y} (508) then contains one element for each row, with each element having only one of two values: t if the row is valid; or f if the row is invalid. From V^{y}, the top boundary y₀¹ (509) and bottom boundary y₀² (510) of submatrix 521 are extracted, so that S₂¹=S₁(1, x₀²−x₀¹; y₀¹, y₀²). Also extracted from V^{y} are the top boundary y₀³ (511) and bottom boundary y₀⁴ (512) of submatrix S₂¹, so that S₂¹=S₁(1, x₀²−x₀^{1; y}₀³, y₀⁴).

The third iteration is shown in FIG. 5C. In the third iteration, submatrix S₂¹ (506) is reduced to submatrix S₃¹ (513) by removing invalid columns. From V^{x} (514), the left boundary x₁¹ (515) and right boundary x₁² (516) of submatrix S₃¹ are extracted, so that S₃¹=S₂¹(x₁¹, x₁²; 1, y₀²−y₀¹+1). At this point, S₃¹ is not reducible in either dimension, is therefore output as a ROI. In this particular example, S₂² is reducible to another ROI, S₃², though the details are not shown.

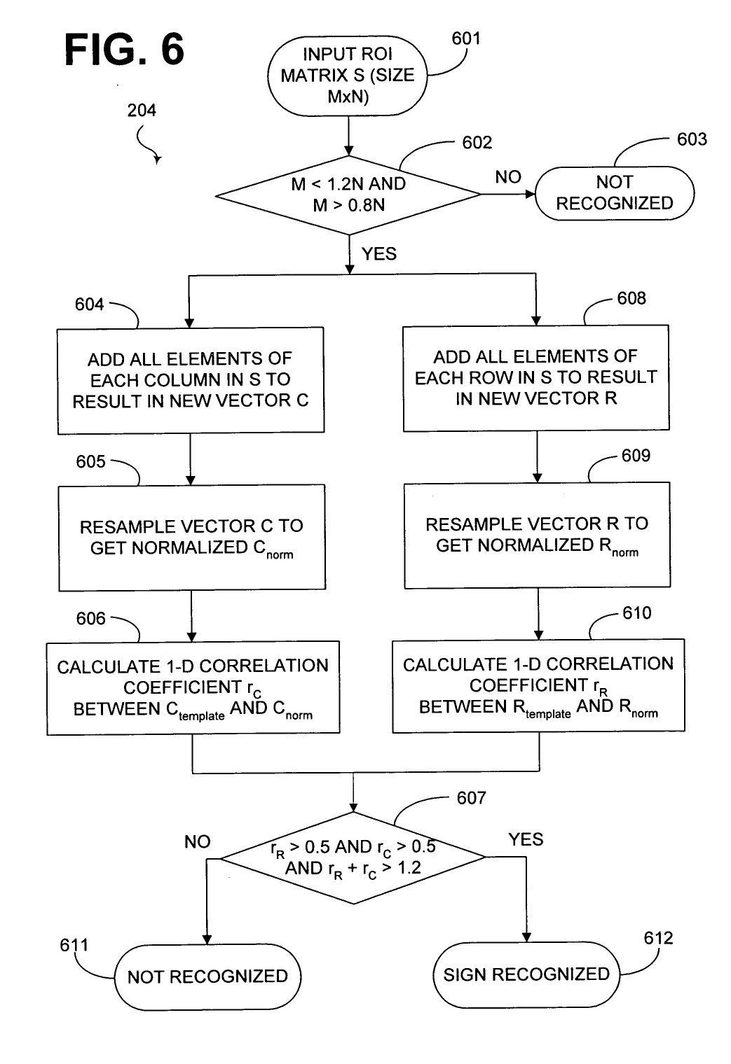

FIG. 6 is a flow chart of the sign detection steps (steps 204 and 205 from FIG. 2) performed by an example embodiment that recognizes stop signs. This process is performed independently on each ROI submatrix produced by the ROI extraction step of FIGS. 3 and 4. This process determines whether or not an ROI submatrix S contains a stop sign by correlating S with a template stop sign matrix T. This produces two correlation coefficients that are compared with a threshold coefficient. The correlation process of this embodiment may be viewed as “one-dimensional” because it correlates rows and columns separately.

Sign detection processing begins at step 601, where a ROI matrix S is provided as input. At the next step, step 602, the aspect ratio of S is compared to a minimum. If the aspect ratio is less than the minimum, then S does not contain a stop sign, and processing finishes at step 603. If the aspect ratio is greater than or equal to the minimum, then processing splits into two paths that can be performed in parallel. Step 604 begins the path which correlates columns in S, while step 605 begins the path which correlates rows in S.

In step 604, a vector C is created by summing all elements of S along columns. Thus, C is a vector with one element for each column in S, and the value of that element is the sum of all elements in that column. The formula for computing vector C is:

$$C = ( \begin{matrix}{\sum }_{i = 1}^{n} S ( 1 , i ) , & {\sum }_{i = 1}^{n} S ( 2 , i ) , & … & {\sum }_{i = 1}^{n} S ( m , i )\end{matrix} )$$

Processing continues at step 604, where vector C is resampled and then normalized to the same size as the column vector Cₜₑₘₚₗₐₜₑ of template matrix T. The result is vector Cₙₒᵣₘ.

Next, at step 606, Cₙₒᵣₘ (columns of the ROI matrix) is correlated with Cₜₑₘₚₗₐₜₑ (columns of the template matrix). The result is correlation coefficient r_{C}, which is computed using the following formula:

$${r}_{C} = \frac{{\sum }_{y} {C}_{norm} \times {C}_{template} - \frac{1}{m} ( {\sum }_{y} {C}_{norm} ) ( {\sum }_{y} {C}_{template} )}{\sqrt{{\sum }_{y} {C}_{norm}^{2} - \frac{1}{m} {( {\sum }_{y} {C}_{norm} )}^{2}} \times \sqrt{{\sum }_{y} {C}_{template} - \frac{1}{m} {( {\sum }_{y} {C}_{ref} )}^{2}}}$$

Column processing is now complete. At step 604, the process waits until the row processing (done by the path starting at step 605) is finished. Row processing is similar to column processing. In step 607, a vector R is created by summing all elements of S along rows. Thus, R is a vector with one element for each row in S, and the value of that element is the sum of all elements in that row. The formula for computing vector R is:

$$R = ( \begin{matrix}{\sum }_{i = 1}^{m} S ( i , 1 ) , & {\sum }_{i = 1}^{m} S ( i , 2 ) , & … & {\sum }_{i = 1}^{m} S ( i , n )\end{matrix} )$$

Processing continues at step 608, where vector R is resampled and normalized to the same size as the row vector Rₜₑₘₚₗₐₜₑ of template matrix T. The result is vector Rₙₒᵣₘ. Next, at step 609, Rₙₒᵣₘ (rows of the ROI matrix) is correlated with Rₜₑₘₚₗₐₜₑ (rows of the template matrix). The result is correlation coefficient r_{R}, which is computed using the following formula:

$${r}_{R} = \frac{{\sum }_{x} {R}_{norm} \times {R}_{template} - \frac{1}{n} ( {\sum }_{x} {R}_{norm} ) ( {\sum }_{x} {R}_{template} )}{\sqrt{{\sum }_{x} {R}_{norm}^{2} - \frac{1}{n} {( {\sum }_{x} {R}_{norm} )}^{2}} \times \sqrt{{\sum }_{x} {R}_{template} - \frac{1}{n} {( {\sum }_{x} {R}_{ref} )}^{2}}}$$

The two paths (row and column) merge at step 604. Step 604 continues processing when correlation coefficients for row (r_{R}) and column (r_{R}) have been computed. At step 604, the row and column coefficients are compared to coefficient threshold values. In this example embodiment, r_{R} is compared to a row threshold (0.5), r_{C} is compared to a column threshold (0.5), and the sum of r_{R} and r_{C} is compared to a 2-D threshold (1.2). If all three conditions are met, then a stop sign has been recognized in ROI S, and processing stops at step 610. If any condition fails, then no stop sign has been recognized in ROI S, and processing stops at step 611.

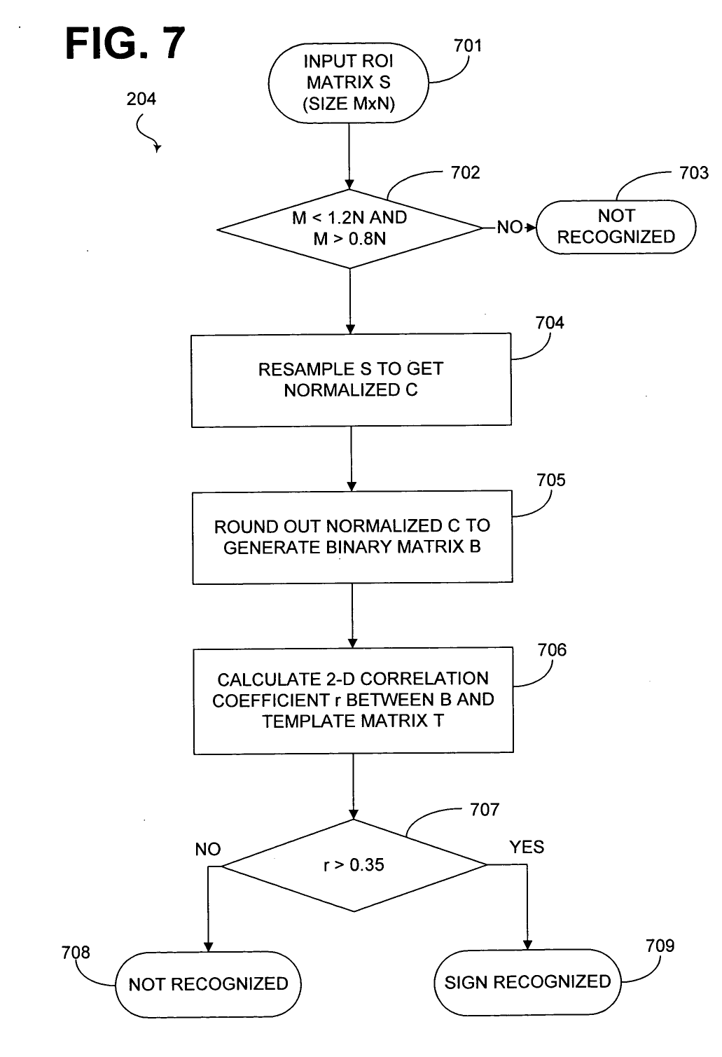

FIG. 7 is a flow chart of the sign detection steps (steps 204 and 205 from FIG. 2) performed by another example embodiment that recognizes stop signs. Like the sign detection process of FIG. 6, this process is performed independently on each ROI submatrix produced by the ROI extraction step of FIGS. 3 and 4. Like the sign detection process of FIG. 6, this process correlates S with a template stop sign matrix T. However, unlike the embodiment previously described with reference to FIG. 6, this embodiment produces a single correlation coefficient relating to both rows and columns. This embodiment may therefore be viewed as “two-dimensional” correlation rather than “one-dimensional” correlation.

Sign detection processing begins at step 701, where a ROI matrix S is provided as input. At the next step, step 702, the aspect ratio of S is compared to a minimum. If the aspect ratio is less than the minimum, then S does not contain a stop sign, and processing finishes at step 703. If the aspect ratio is greater than or equal to the minimum, then processing continues at step 704.

At step 704, submatrix S is resampled and normalized to the same size as template matrix T. The result is a normalized matrix C. Each element C(i,j) is obtained by first mapping to the corresponding element or elements in the submatrix S. Since C is a square matrix of size s×s, and S is a matrix of size m×n, the element C(i,j) can be mapped to S(im/s,jn/s) if both im/s and jn/s are integers. If not, there is no corresponding element in S that maps exactly back to C(i,j). However, we can approximate the value at S(im/s,jn/s) by calculating the weighted sum of its four neighboring elements. The four neighboring elements are:

$$S ( ⌊ \frac{im}{s} ⌋ , ⌊ \frac{jn}{s} ⌋ ) , S ( ⌊ \frac{im}{s} ⌋ , ⌈ \frac{jn}{s} ⌉ ) , S ( ⌈ \frac{im}{s} ⌉ , ⌊ \frac{jn}{s} ⌋ ) , S ( ⌈ \frac{im}{s} ⌉ , ⌈ \frac{jn}{s} ⌉ )$$

When summing, the weight given to each neighboring element is based on its horizontal and vertical distances from the center element, which are:

$$dx = \frac{im}{s} - ⌊ \frac{im}{s} ⌋ , dy = \frac{jn}{s} - ⌊ \frac{jn}{s} ⌋$$

The above analysis results in the following formula for C:

$$C ( i , j ) = ( 1 - dx ) ( 1 - dy ) S ( ⌊ \frac{im}{s} ⌋ , ⌊ \frac{jn}{s} ⌋ ) + ( 1 - dx ) dyS ( ⌊ \frac{im}{s} ⌋ , ⌈ \frac{jn}{s} ⌉ ) + dx ( 1 - dy ) S ( ⌈ \frac{im}{s} ⌉ , ⌊ \frac{jn}{s} ⌋ ) + dxdyS ( ⌈ \frac{im}{s} ⌉ , ⌈ \frac{jn}{s} ⌉ )$$

Returning to FIG. 7, step 704 is now finished, having created a normalized matrix C based on ROI submatrix S, with elements having values between 0 and 1. Processing continues at step 705, where the elements of the normalized matrix C are rounded to either 0 or 1 to produce a binary matrix B, using the formula:

$$B ( i , j ) = \{ \begin{matrix}0 & C ( i , j ) < 5 \\ 1 & C ( i , j ) \geq 5\end{matrix} \}$$

Next is step 706, where B (based on the ROI matrix) is correlated with T (the shape template matrix). The result is correlation coefficient r, which is computed using the following formula:

$$r = \frac{{\sum }_{i = 1}^{s} {\sum }_{j = 1}^{s} R ( i , j ) B ( i , j ) - 1 / {s}^{2} {R}_{sum} {B}_{sum}}{\sqrt{{R}_{sum} ( 1 - \frac{{R}_{sum}}{{s}^{2}} ) {B}_{sum} ( 1 - \frac{{B}_{sum}}{{s}^{2}} )}}$$

where

$${R}_{sum} = {\sum }_{i = 1}^{s} {\sum }_{j = 1}^{s} R ( i , j )$$

and

$${B}_{sum} = {\sum }_{i = 1}^{s} {\sum }_{j = 1}^{s} B ( i , j ) .$$

This formula takes advantage of the fact that R²(i,j)=R(i,j) because each R(i,j) is limited to either 1 or 0.

After the correlation coefficient r is computed, processing continues at step 707, where the coefficient r is compared to a coefficient threshold value. If the coefficient is above the threshold, then a stop sign has been recognized in ROI S, and processing stops at step 708. If any condition fails, then no stop sign has been recognized in ROI S, and processing stops at step 709.

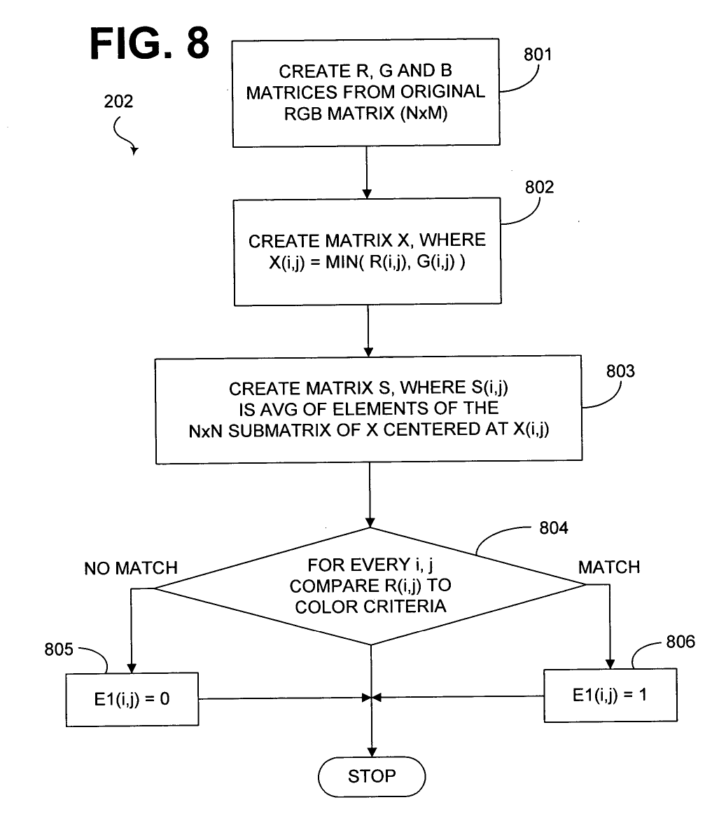

The example embodiment of FIGS. 2-6 recognizes stop signs. Yet another embodiment of the invention recognizes speed limit signs. FIG. 8 is a flow chart of the color segmentation step (step 202 from FIG. 2) performed by this example embodiment that recognizes speed limit signs. In this embodiment, the color segmentation process segments an image based on color characteristics of a speed limit sign, which is black symbols on a white background. Segmentation is performed by comparing the color components at each pixel location with color criterion.

The example embodiment of FIGS. 2-6 used a color criterion that was the same for each pixel location. However, using such a global criterion for speed limit signs would not be effective to separate matching from non-matching pixels under a wide range of lighting conditions, because the black-and-white color pattern of a speed limit sign is typically more common than the red color of a stop sign. A more effective color criterion takes advantage of the fact that speed limit sign pixels are relatively darker than surrounding background pixels. Another variation takes advantage of pixels that are relatively lighter than surrounding background (e.g., an interstate sign). Therefore, the color criterion used in this embodiment is locally adaptive, so that the threshold for segmenting a match from a non-match varies depending on pixel location.

Returning now to the flow chart of FIG. 8, the captured digital image is represented by a Red/Green/Blue (RGB) matrix of size n×m. Each pixel location in the RGB matrix has a separate Red value, Green value, and Blue value. The color segmentation process begins with step 801, which separates the RGB matrix into three matrices, R, G, and B, each having the same dimensions as the RGB matrix. The R matrix contains only the Red values from the corresponding pixel locations in the RGB matrix. Likewise, the B matrix, contains only Blue values and the G matrix contains only Green values.

Processing continues at step 802, where a new X matrix is created. The X matrix has the same dimensions as the R, G, and B matrices, and X(i,j)=min(R(i,j),G(i,j)). Note that here the B component is not used because in a speed limit sign with a yellow background, the B component in the digit could be weaker than either the R or the G component in the yellow background, so that the digit would not be effectively segmented from its background. Yet the B component can be ignored without affecting the accuracy when used with black-on-white signs.

Next, at step 803, a color criterion matrix S is derived from X. Each element, S(i,j), was the average of n×n elements of the X matrix centered at S(i,j). That is,

$$S ( i , j ) = \{ \begin{matrix}\frac{1}{{n}^{2}} {\sum }_{k = i = n / 2}^{i + n / 2} {\sum }_{l = j = n / 2}^{j + n / 2} X ( k , l ) , & \frac{n}{2} < i < M - \frac{n}{2} and \frac{n}{2} < j < N - \frac{n}{2} \\ 0 , & otherwise\end{matrix} \}$$

where M is the row size of X and N is the column size of X. In this equation, the threshold values of those pixels whose distance to the image border was less than n/2, in either direction, are set to 0. This is done because there is no submatrix of size n×n centered at those pixels.

Processing continues at step 804, where a binary segmentation matrix E is derived from S, R and G. In step 804, each element of E is compared to the locally adaptive color criterion for that pixel. Depending on the results of the comparison, the element of E is set to a value by either step 805 or step 806. The elements of E are set according to the following formula:

$$E ( i , j ) = \{ \begin{matrix}1 , & R ( i , j ) \leq 0.9 S ( i , j ) and G ( i , j ) \leq 0.9 S ( i , j ) \\ 0 , & otherwise\end{matrix} \}$$

At this point, binary segmentation matrix E contains 1's at locations that match the color criterion, and 0's at locations that do not match. This segmentation matrix is used as input to the ROI extraction process (step 203 from FIG. 2).

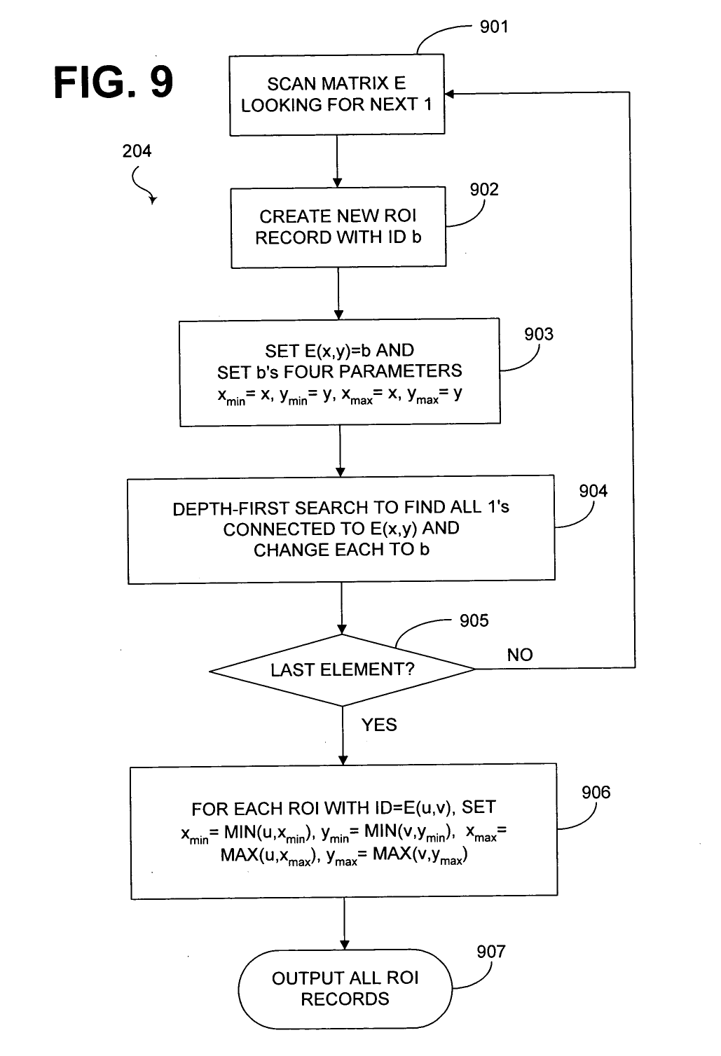

FIG. 9 is a flow chart of the ROI extraction step (step 203 from FIG. 2) performed by an example embodiment that recognizes speed limit signs. A speed limit sign contains digits, each one an isolated object surrounded by a background. The ROI extraction process finds ROIs within E, each of which potentially contains a speed limit digit, based on distributions of color within E. Since matrix E is a binary matrix containing 1's where there is a color match, each ROI is a submatrix Sₖ containing a block of connected 1 elements surrounded by 0 elements. Submatrix Sₖ(x1:x2; y1:y2) covers columns from x1 to x2 and rows from y1 to y2.

The ROI extraction step for this embodiment begins at step 901, where binary matrix E is scanned for the next occurrence of a 1. Scanning stops at E(x,y) when E(x,y)=1, indicating the start of a new ROI. Next, at step 902, a new ROI record is created. The ROI record has parameters for id, xₘᵢₙ, yₘᵢₙ, xₘₐₓ and yₘₐₓ. The id field is set to a new id. At the next step, step 903, the value at E(x,y) is set to the id of the ROI record, xₘᵢₙ and xₘₐₓ, are set to x, and yₘᵢₙ and yₘₐₓ are set to y.

Processing continues at step 904. Step 904 performs a depth-first search to find all elements with value 1 that are connected to E(x,y), and changes the value of these elements to the ROI id. Two elements are connected if they meet two conditions. First, both elements must have a non-zero value (1 or ROI id). Second, either the two elements are neighbors, or one element is connected to the other element's neighbor.

The next step, step 905, determines whether the last element in the matrix E has been scanned. If No, then processing continues at step 901, where the scan continues. If Yes, then processing continues at step 906. Step 906 updates the parameters for each ROI record. As initialized, these parameters define a ROI matrix that contains only a single element, the 1 marking the start of the ROI. The ROI matrix is now expanded to include all elements with a value equal to the ROI id.

To update a particular ROI record, all elements with a value equal to the ROI id are examined. For each element E(u,v) found, the ROI record parameters are updated according to the following formula:

$$\{ \begin{matrix}{x}_{min} = min ( {x}_{min} , u ) \\ {y}_{min} = min ( {y}_{min} , v ) \\ {x}_{min} = max ( {x}_{max} , u ) \\ {y}_{min} = max ( {y}_{max} , v )\end{matrix} \}$$

At the end of the search, the ROI record defines a matrix that includes all elements with a value equal to the ROI id.

Processing ends at step 907, where the ROI records are output. Each record defines a ROI matrix. Later stages will correlate the set of ROI matrices with digit template matrices in order to determine if the set describes a speed limit sign.

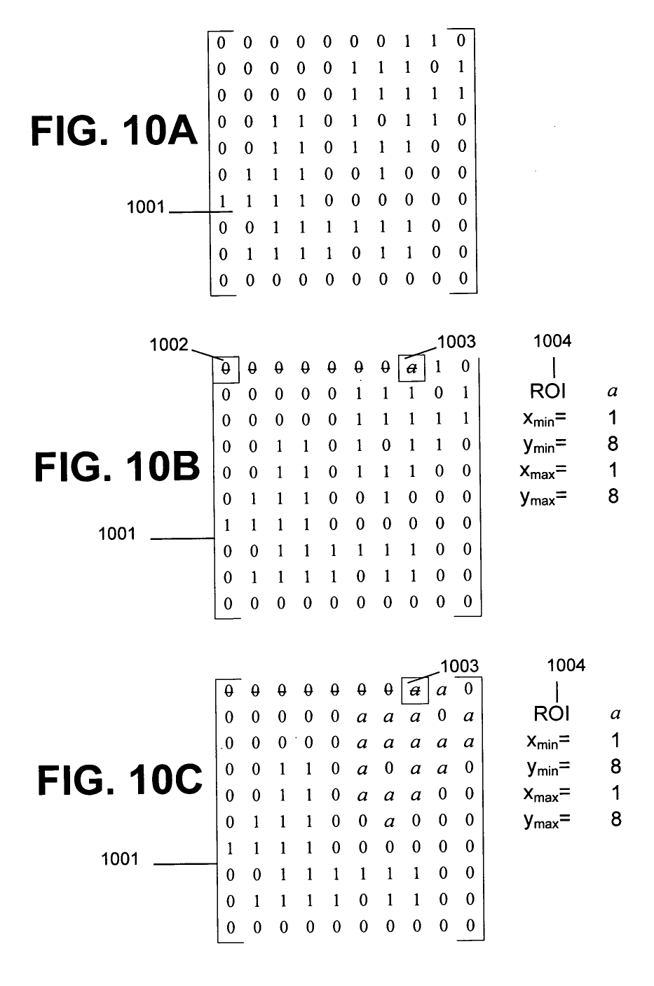

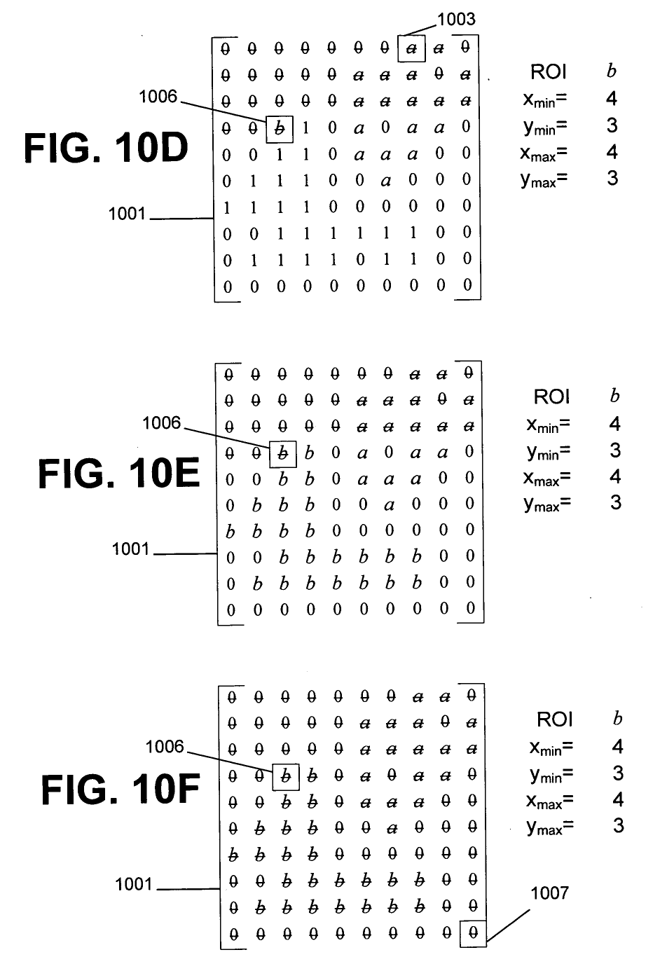

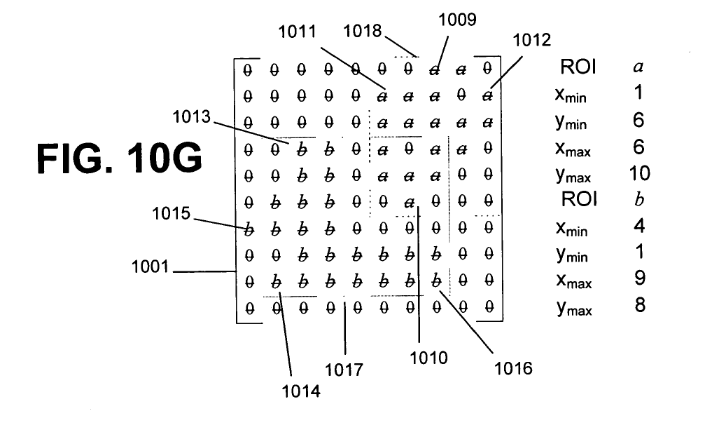

FIGS. 10A-C are a sequence of diagrams showing the ROI process of FIG. 9 as applied to an example matrix E (1001). FIG. 10A shows the initial conditions at the start of the process, with the input matrix E (1001).

In FIG. 10B, matrix E is scanned for the next occurrence of a 1. The scan starts at initial element 1002, and stops with the first 1, at element 1003. A new ROI record (1004) is created and assigned an id, a (1005). The value 1 at the stop element is replaced by this id a. The minimum and maximum parameters of the ROI record are initialized with the x,y position of the stop element, which is (1,8).

In FIG. 10C, a depth-first search finds all elements connected to the last stop element (1003) that have value 1. The value of these elements is set to id a. The scan position is not advanced, so is still at 1003.

In FIG. 10D, the scan for the next occurrence of a 1 continues. The scan starts from the position of the last stop element (1003) and stops at the next 1 (1006). A new ROI record (1007) is created and assigned an id, b. The value 1 at the stop element is replaced by this id b. The minimum and maximum parameters of the ROI record are initialized with the x,y position of the stop element, which is (4,3).

In FIG. 10E, a depth-first search finds all elements connected to the last stop element (1006) that have value 1. The value of these elements is set to id b. The scan position is not advanced, so is still at 1006.

In FIG. 10F, the scan for the next occurrence of a 1 continues. The scan starts from the position of the last stop element (1006). There are no further occurrences of a 1 in matrix E, so the scan stops at the last element (1008).

In FIG. 10G, each ROI record is updated with new maximum and minimum parameters. The matrix is scanned looking for values matching the ROI id. Each time an id match is found, the maximum and minimum parameters are updated, taking into account the x,y position of the matching element.

In this example, the ROI record for id a is updated as follows. The minimum x value of any element with id equal to a is 1, corresponding to element 1009. The maximum×value of any element with id equal to a is 6, corresponding to element 1010.

The minimum y value of any element with id equal to a is 6, corresponding to element 1011. The maximum y value of any element with id equal to a is 10, corresponding to element 1012.

The ROI record for id b is updated in a similar manner. The minimum×value of any element with id equal to b is 4, corresponding to element 1013. The maximum x value of any element with id equal to b is 9, corresponding to element 1014. The minimum y value of any element with id equal to b is 1, also corresponding to element 1014. The maximum y value of any element with id equal to b is 8, corresponding to element 1015.

The two updated ROI records thus define two ROI submatrices, 1016 and 1017. In this example, the ROI submatrices overlap.

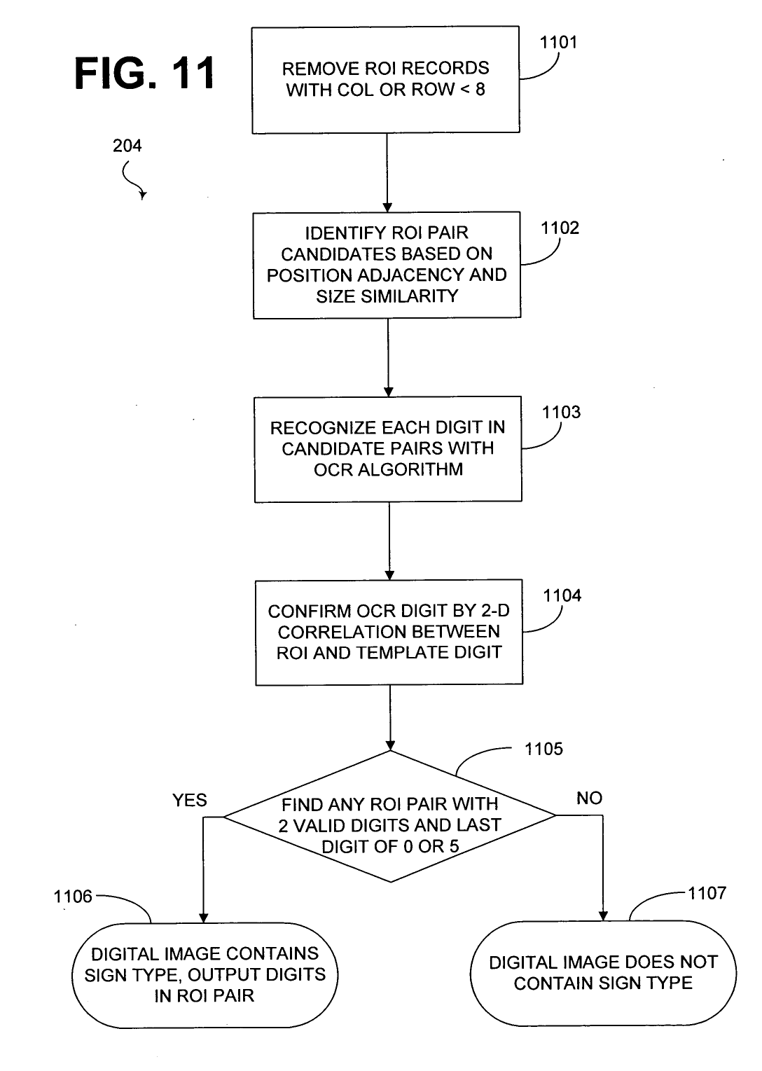

FIG. 11 is a flow chart of the sign detection steps (steps 204 and 205 from FIG. 2) performed by an example embodiment that recognizes speed limit signs. Using as input the set of ROI submatrices S, this process determines whether or not the set of ROIs describes a speed limit sign. Because speed limit signs are characterized by a pair of digits, the set of ROI submatrices S is considered as a whole. This differs from the stop sign detection processes of FIGS. 6 and 7, which consider each ROI submatrix separately.

Processing begins at step 1101, where all submatrices S with either a row or a column size less than a minimum value are discarded. Next, at step 1102, pairs of ROIs are identified as candidates for speed limit digits, based on position adjacency and size similarity.

A speed limit sign consists of a pair of adjacent digits. The digits have similar heights and widths, and the distance between them is smaller than the sum of the digits' widths. Therefore, a pair of ROI speed limit candidates has only two ROIs adjacent to each other, with similar widths and heights. The adjacency test determined that the centers of the two ROIs were almost in the same row, and that the distance between the centers was less than the sum of the ROI widths. In addition, any ROI having more than one adjacent ROI is rejected, as are those adjacent ROIs.

Processing continues at step 1103. At this step, an OCR algorithm is used to recognize the digit represented by each ROI speed limit candidate. OCR algorithms are well known in the art of image processing. In this example embodiment, the algorithm used was developed by Kahan to identify printed characters of any font and size.

The next step, step 1104, confirms the digit recognized in each ROI by correlating the ROI with a digit-specific template matrix R. There are 10 template digits, representing the digits 0-9. The correlation process involves normalizing the ROI matrix to the size of the template matrix, rounding the values in the normalized ROI matrix to produce a binary ROI matrix T, and calculating the correlation between the binary ROI matrix T and the template matrix R. The correlation process is the same discussed earlier with respect to the 2-D stop sign correlation, steps 704-706 of FIG. 7. The result of the correlation process is a correlation coefficient r.

After the correlation coefficient r is computed, processing continues at step 1105, where the coefficient r is compared to a coefficient threshold value. In one embodiment, the coefficient threshold value is 0.35. If the coefficient is above the threshold, then a speed limit sign has been recognized in the set of ROI submatrices S, and processing stops at step 1106. If not, then no speed limit sign has been recognized in the set of ROI submatrices S, and processing stops at step 1107.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

Therefore, having thus descibed the invention, at least the following is claimed:

1. A method for recognizing a road sign in a digital color image, where the road sign is associated with a shape template and at least one color criterion, the method comprising:
capturing a digital color image;
correlating at least one region of interest within the digital color image with a template matrix, where the template matrix is specific to a reference sign; and
recognizing the image as containing the reference sign, responsive to the correlating step.

2. The method of claim 1, further comprising:
performing color segmentation on the digital color image to produce at least one matrix;
extracting at least one region of interest from the matrix to produce at least one submatrix containing at least one potential road sign;
correlating the at least one submatrix with a template matrix to produce a correlation coefficient, where the reference matrix is specific to a reference sign; and
recognizing the image as containing the reference sign, based upon a comparison of the correlation coefficient and a correlation threshold value.

3. The method of claim 1, wherein the performing step further comprises:
setting each element of the matrix to a first value if the corresponding pixel position in the digital color image matches any of the at least one color criterion associated with the road sign.

4. The method of claim 1, wherein the at least one color criterion comprises:
a first color selected from R,G,B being greater than a first threshold value; and
a saturation value for the first color being greater than a second threshold value, where the saturation value is calculated using a hue, saturation and intensity model.

5. The method of claim 4, wherein the at least one color criterion is locally adaptive such that the first threshold value varies at each location within the matrix.

6. The method of claim 5, wherein the first threshold value at a location X(i,j) is the average of a square submatrix centered at X(i,j).

7. The method of claim 1, further comprising a second color criterion, where the first criterion is used in dim light conditions and the second criterion is used in bright light conditions.

8. The method of claim 7, wherein the second color criterion comprises:
a second color selected from R,G,B being greater than a third threshold value; and
a saturation value for the second color being greater than a fourth threshold value, where the saturation value is calculated using a hue, saturation and intensity model. The method of claim 1, where the matrix contains only binary values.

9. The method of claim 1, where the matrix contains only binary values.

10. The method of claim 1, further comprising:
recursively removing any invalid row and any invalid column from the matrix, where an invalid row contains less than a first threshold value of a binary value and an invalid column contains less than a second threshold value of the binary value.

11. The method of claim 1, where the correlating step further comprises:
creating a validating column vector corresponding to all columns in the submatrix;
creating a validating row vector corresponding to all rows in the submatrix;
correlating the validating column vector with a template column vector; and
correlating the validating row vector with a template row vector.

12. The method of claim 1, where the correlating step further comprises:
normalizing the submatrix, such that each element in the normalized submatrix is the weighted sum of the element's four neighboring elements.

13. The method of claim 1, where the correlating step further comprises calculating a two-dimensional correlation coefficient which measures the correlation between the submatrix and a two-dimensional template matrix.

14. The method of claim 1, where the correlating step further comprises calculating a two-dimensional correlation coefficient which measures the correlation between the submatrix and a two-dimensional template matrix.

15. The method of claim 1, where the extracting step further comprises:
scanning the matrix for a element with value 1 at position E(x,y); and
performing a depth-first-search to find all elements with value 1 that are connected to E(x,y);

16. The method of claim 15, where the extracting step further comprises:
setting the element at position E(x,y) to a unique identifier; and
setting the value of the connected elements to the unique identifier.

17. A computer readable medium having a computer program for recognizing a road sign in a digital color image, where the road sign is associated with a shape template and at least one color criterion, comprising:
logic configured to capture a digital color image;
logic correlate at least one region of interest within the digital color image with a template matrix, where the template matrix is specific to a reference sign; and
logic configured to recognize the image as containing the reference sign, responsive to the correlation logic.

18. A system for recognizing a road sign in a digital color image, where the road sign is associated with a shape template and at least one color criterion, the method comprising:
means for capturing a digital color image;
means for correlating at least one region of interest within the digital color image with a template matrix, where the reference matrix is specific to a reference sign; and
means for recognizing the image as containing the reference sign, responsive to the correlation means.
